(19) United States
(12) Patent Application Publication
(10) Pub. No.: US 2016/0146351 A1
(43) Pub. Date: May 26, 2016

(54) Rosette lipseal

(71) Applicant: Robert Janian, L. A., CA (US)

(72) Inventor: Robert Janian, L. A., CA (US)

(21) Appl. No.: 14/757,223

(22) Filed: Jun. 23, 2014

(51) Int. Cl. F16J 15/3284; F16J 15/324; F16J 15/3204

(52) U.S. Cl. CPC F16J 15/3284; F16J 15/3204; F16J 15/324

(57) ABSTRACT

A mechanical lip seal assembly preventing leaking oil and similar fluids from rotary shafts in gearboxes. This lip seal assembly comprising in combination a casing commonly made of metal which in turn contains a resilient lip seal element made of low friction plastic such as PTFE. This invention describes a resilient lip sealing element structure along in combination with a flat metallic rosette spring washer where inner and outer diameters are connected by isolated angular nodes which in turn this rosette spring is compressed onto low friction plastic sealing element containing pressure balancing and pressure transfer grooves located on opposite surface where the metallic rosette spring is compressed into.

### FIELD OF INVENTION

This invention pertains to mechanical lip seals used in low pressure systems sealing oil and similar fluids from splashing and leaking out of gearboxes.

### BACKGROUND OF THE INVENTION

The prior art utilizes the use of mechanical lip seal assembly consisting of a resilient sealing element made of a low friction plastic such as PTFE, constrained inside a metal canister, this assembly in turn is compressed inside a gearbox housing bore such that the inner lip of resilient sealing element comes in contact with the rotating shaft inside gear box to seal oil and similar fluids from leaking out of gearbox, as the shaft rotates constant friction caused by dynamic surface between sealing lip and rotating shaft results sealing lip wear and seal failure, this invention makes it possible to reduce rate of wear thus improving seal performance and seal life.

### STATEMENT OF INVENTION

This invention contemplates a circular washer sealing element made of low friction plastic such as PTFE with definite inner and outer diameter, looking down flat on one surface of this sealing element there is a circumferential groove located near inner diameter and four angular channels each separated by 90 degrees apart running from circumferential groove inward through inside diameter, two channels located 180 degrees apart from each other angled clockwise from X-axis running left to right and the other two located 180 degrees apart from each other are running counterclockwise right to left from Y-axis, in turn this sealing element is compressed over a flat metallic rosette spring with isolated angular nodes running from inner diameter to the outer such that the surface of resilient sealing element with the circumferential groove and angular channels are located opposite to surface which contacts the metallic rosette spring, combination of resilient sealing element and the rosette spring is compressed together and sandwiched inside a metallic canister and an “L” shaped retainer ring as one assembly, in turn this assembly is compressed inside the gearbox housing bore diameter and as the gearbox shaft is pushed through inside diameter of sealing element from direction of circular groove and four channels expands inner diameter of sealing element creating interference between sealing element and rotating shaft, as the shaft rotates clockwise or counterclockwise with the oil inside gearbox the shaft surface pushes the oil through the angular channels which leads the oil into the circumferential groove located just near sealing lip surface, this constant flow of liquid oil inside circumferential groove creates pressure balancing and less friction resulting longer seal life.

### BRIEF DESCRIPTION OF THE DRAWING

There are 7 pages to the drawing

FIG. 1 shows cross section of lip seal assembly where sealing element and rosette spring are sandwiched inside metal canister and retainer ring.

FIG. 2 is back view of lip seal assembly of FIG. 1

FIG. 3 is front view of lip seal assembly of FIG. 1

FIG. 4 is front view of lip seal element

FIG. 5 shows section A-A of FIG. 4 lip seal element

FIG. 6 is front view of metallic rosette spring.

FIG. 7 is side view of metallic rosette spring

FIG. 8 is front view of sealing element and rosette spring sandwiched together.

FIG. 9 is cross section A-A of sealing element and rosette spring sandwiched and pressed together.

FIG. 10 shows lip seal assembly compressed inside gear box housing bore as rotating shaft is running through inside diameter of lip seal element.

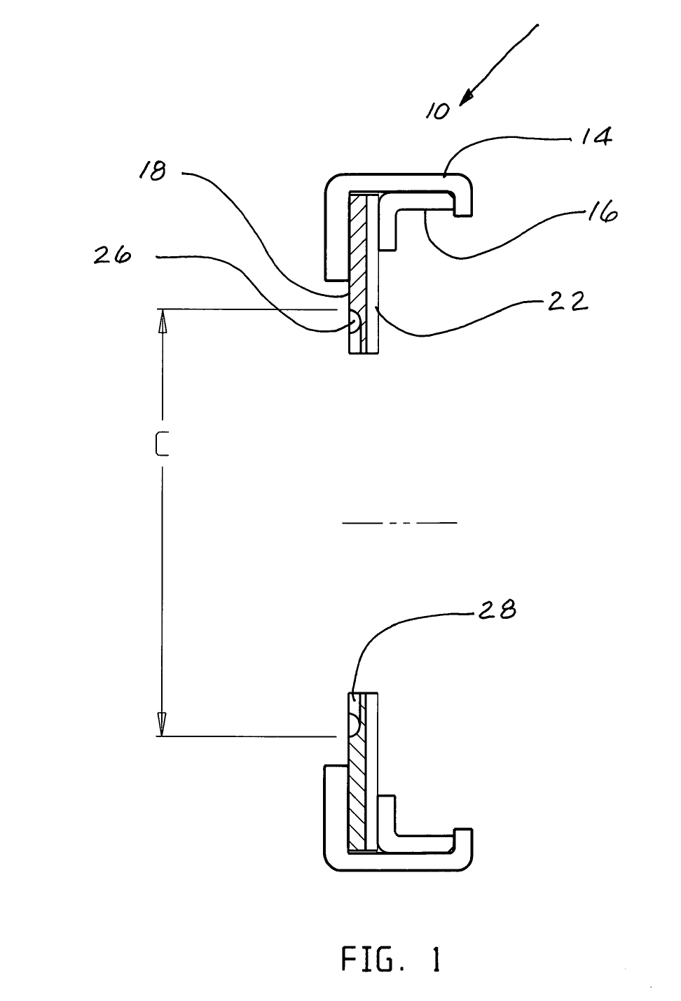

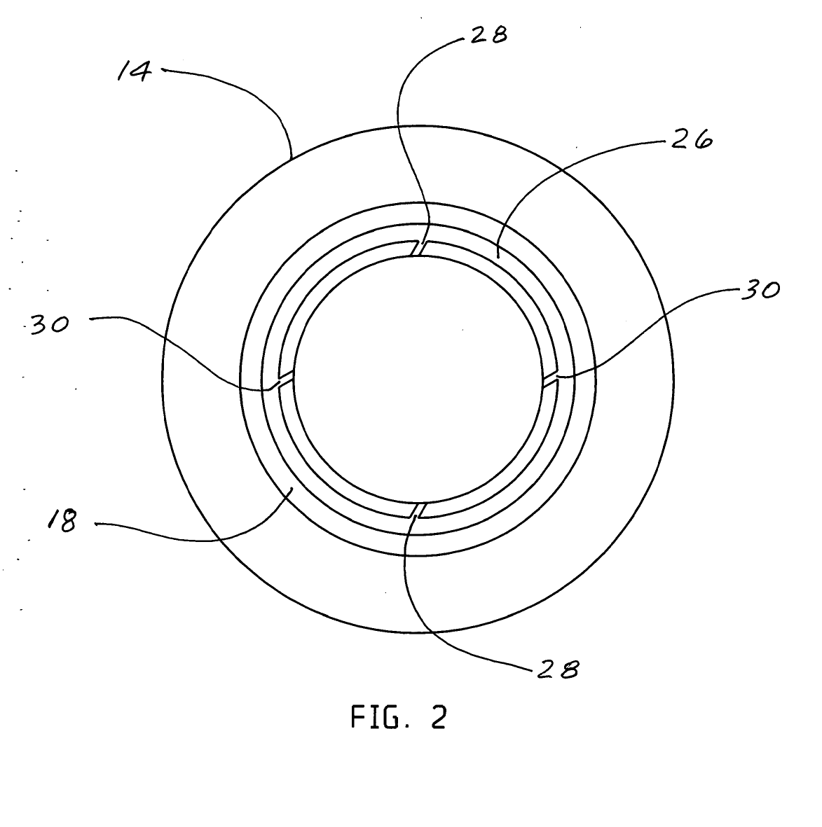

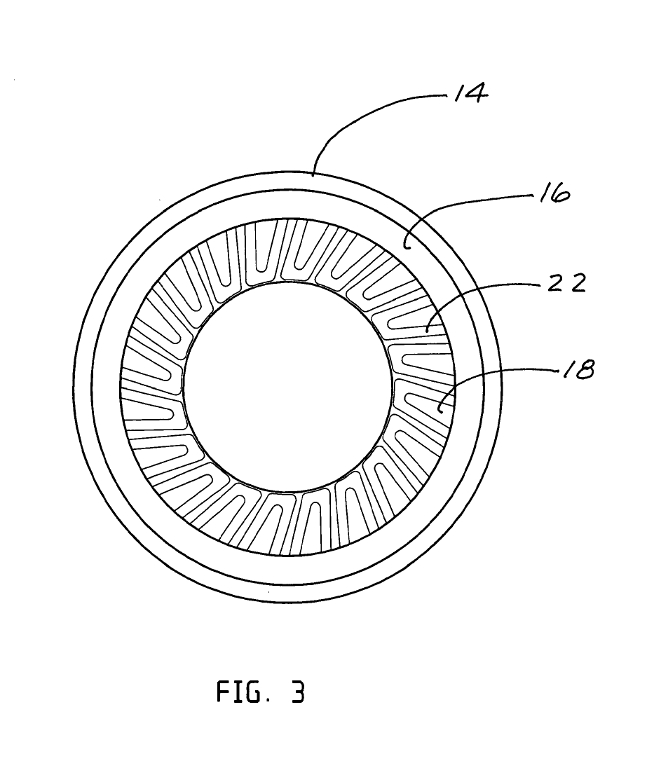

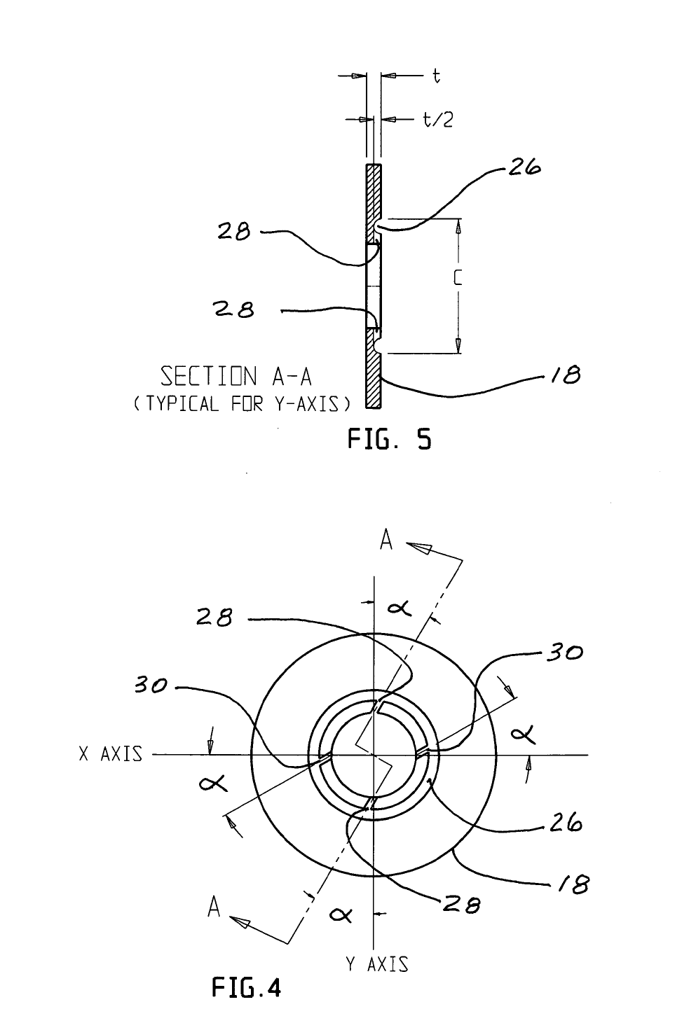

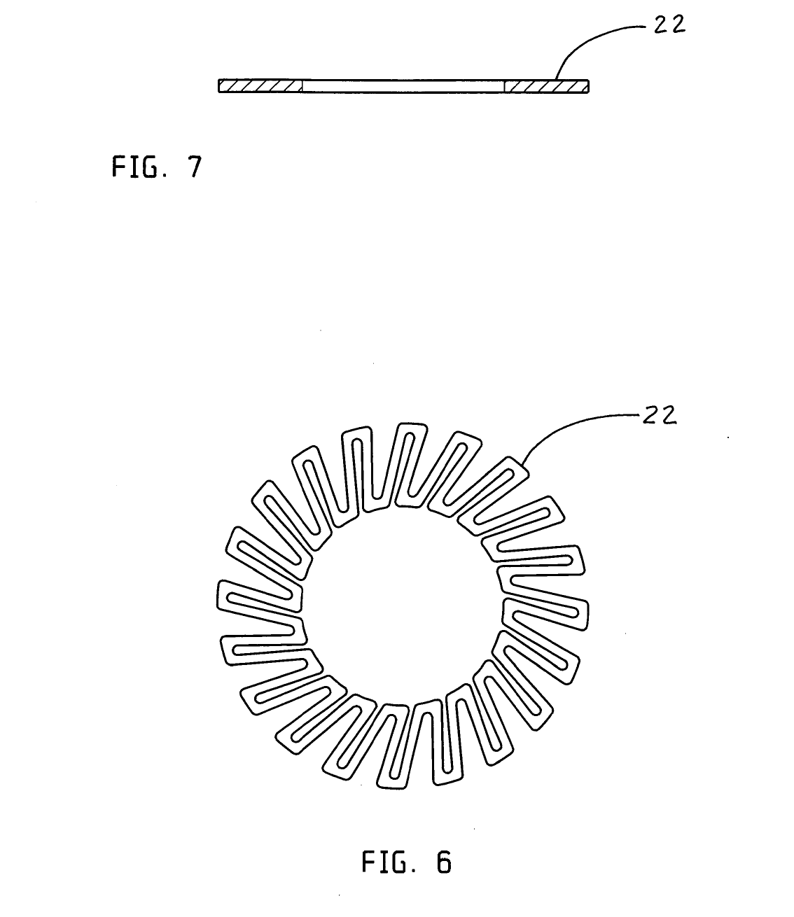

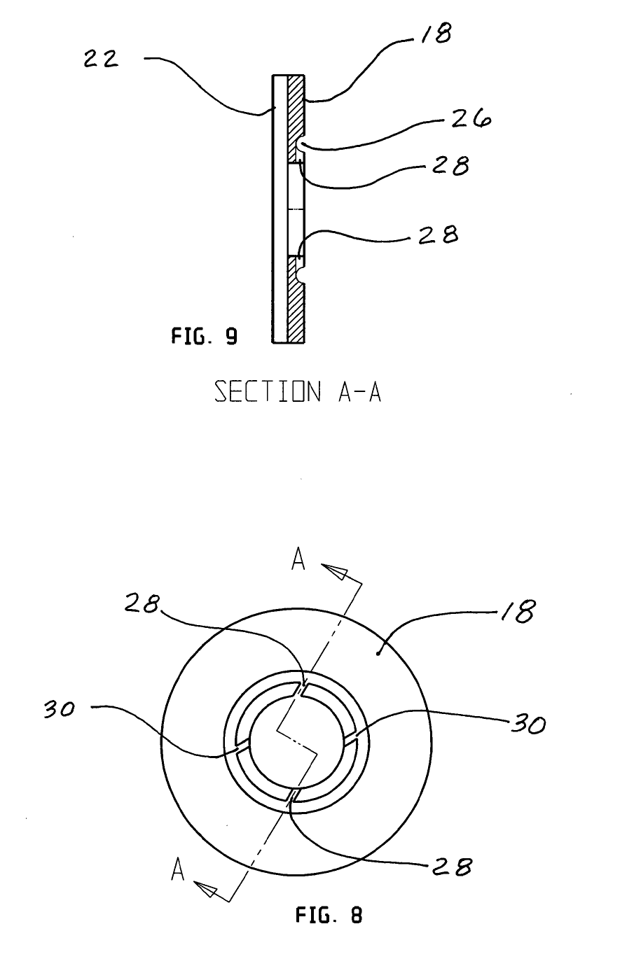

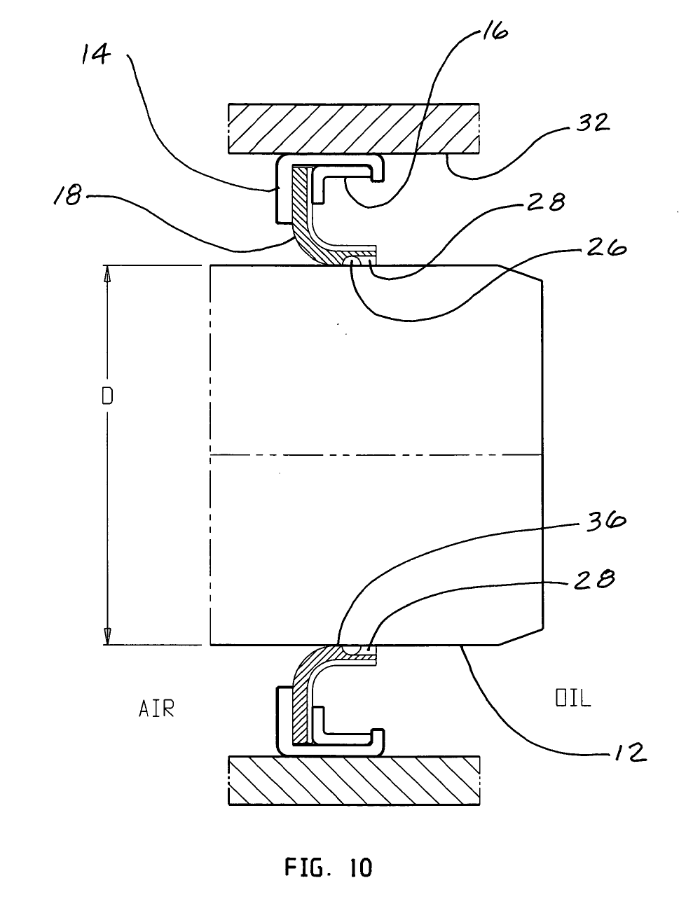

### DETAILED DESCRIPTION OF THE INVENTION

In the drawing, a lip seal assembly 10 comprising a flat circular washer sealing element 18 made of a resilient low friction plastic such as PTFE, as looking down flat on one surface of this sealing element 18 there is a circumferential groove 26 close to inner diameter and four channels 28 and 30 joining circumferential groove through to inner diameter of sealing element 18, channels 28 and 30 each are 90 degrees apart, channels 28 located on Y-axis of sealing element 18 are 180 degrees apart and channels 30 located on X-axis of sealing element 18 are 180 degrees apart, sealing element 18 thickness (t) is 0.030 to 0.060 inch and circumferential groove 26 with four adjoining channels 28 and 30 are ½ thickness of sealing element 18 (t/2) deep. Channels 28 are angled (∝) degrees clockwise from Y-axis of seal ring 18 where (∝) is between 15 and 30 degrees, channels 30 are angled (∝) degrees counterclockwise from X-axis of seal ring 18 where (∝) is between 15 and 30 degrees. Sealing element 18 and rosette spring 22 are located inside metallic canister 14 and sandwiched between an “L” shaped metallic retaining ring 16 and metallic canister ring 14, sealing element circumferential groove 26 with adjoining four channels 28 and 30 are positioned opposite side of rosette spring 22 and metallic “L” shaped retaining ring 16, maximum diameter “C” of circumferential groove 26 is equal to or less than shaft 12 diameter “D”, this assembly in turn is pressed inside gearbox housing bore 32, shaft 12 is inserted from direction of circumferential groove 26 side and through inside diameter of sealing element 28 expanding inside diameter of sealing element 28 along with rosette spring 22 creating interference with shaft outside diameter surface 12 and sealing element 18 resulting sealing surface 36. When the gearbox is in operation and shaft 12 is rotating in clockwise motion it creates constant oil flow through channels 28 into circumferential groove 26 thus creating pressure balancing and lubricating action at sealing lip surface resulting longer seal life, similarly, with counterclockwise shaft rotation oil is being pushed through channels 30 and creating oil flow into circumferential groove 26 in counterclockwise motion thus resulting balanced pressure and lubricity for sealing lip surface 36 resulting longer seal life. 18 resulting sealing surface 36. When the gearbox is in operation and shaft 12 is rotating in clockwise motion it creates constant oil flow through channels 28 into circumferential groove 26 thus creating pressure balancing and lubricating action at sealing lip surface resulting longer seal life, similarly, with counterclockwise shaft rotation oil is being pushed through channels 30 and creating oil flow into circumferential groove 26 in counterclockwise motion thus resulting balanced pressure and lubricity for sealing lip surface 36 resulting longer seal life.

I claim:

1. A flat circular washer sealing element on one face having a circumferential groove close to inner diameter and four channels joining circumferential groove through to inner diameter of circular sealing element.

2. The thickness of sealing element claim 1 is 0.030 to 0.060 in. thick.

3. Depth of circumferential groove and four adjoining channels of sealing element of claim 1 equals to ½ thickness of sealing element in claim 1.

4. Four adjoining channels in claim 1 are 90 degrees apart.

5. Two of adjoining channels of claim 4 are located on Y-axis face of sealing element of claim 1 other 2 are located on X-axis face of sealing element of claim 1.

6. Two of adjoining channels on Y-axis of claim 5 are angled 15 to 30 degrees clockwise from Y-axis face of sealing element of claim 1 and two of adjoining channels on X-axis face of sealing element of claim 5 are angled 15 to 30 degrees counterclockwise from X-axis face of sealing element of claim 1.

7. A metallic flat rosette spring is compressed on sealing element of claim 1 on opposite surface where circumferential groove and four adjoining channels of claims 4 and 5.

8. Maximum outside diameter of circumferential groove in claim 1 is equal or less than rotating shaft diameter.
